(19) United States
(12) Patent Application Publication
(10) Pub. No.: US 2012/0163133 A1
(43) Pub. Date: Jun. 28, 2012

(54) Timepiece and Urn Combination Device

(76) Inventor: Bill Gonzales, Temple, OK (US)

(21) Appl. No.: 13/332,872

(22) Filed: Dec. 21, 2011

Related U.S. Application Data
(60) Provisional application No. 61/426,114, filed on Dec. 22, 2010.

(51) Int. Cl. G04B 47/00; G04F 1/06

(52) U.S. Cl. 368/10

(57) ABSTRACT

An architecture is presented that provides an hourglass device that can be used as a decorative urn to allow users to display the remains of their loved one in a respectful manner, while also accommodating the storage of valuables in a surreptitious manner. The hourglass and urn combination device is preferably comprised of a base with a hidden compartment contained therein, a top, more than one pillar, a hourglass, and an hourglass support structure that permits the hourglass to rotate with respect thereto. The hourglass may be filled with sand, soil and/or the cremated remains of a loved one such as a family member, friend or pet, or the cremated remains may be stored in the secret compartment in the base with other valuables such as money, jewelry and the like.

### CROSS-REFERENCE

This application claims priority from Provisional Patent Application Ser. No. 61/426,114 filed Dec. 22, 2010.

### FIELD OF THE INVENTION

This invention relates to an improved urn device for storing the cremated remains of a loved one and other valuables in a stylish and functional timepiece.

### BACKGROUND

Many individuals keep the cremated remains of their beloved family members, friends or pets in a decorative urn or other container. However, oftentimes individuals do not feel as though conventional urns are special enough to be displayed on a fireplace mantel or other highly visible area within a home. Thus, many individuals place these urns in their closet or in storage. Families and others often desire a more respectful way to honor their deceased loved ones.

Many individuals are also concerned about safely storing money, jewelry and other valuable assets in a surreptitious manner to prevent the same from being lost or stolen. Heretofore, many individuals stored such assets in a safety deposit box at a bank, or in a large safe or strong box, neither of which are particularly convenient to access. Moreover, a safe or strong box is typically one of the first places that a thief will look for valuables, oftentimes stealing or taking the whole safe or strong box if the same is not secured to the structure in which it is housed.

Still other individuals desire to also display a decorative or elegant timepiece, such as an hourglass, on their mantle or in other highly visible areas of the home. Consequently, there exists a long-felt need for a device that combines a timepiece, such as an hourglass, with an urn, and that permits an individual to honor and display the cremated remains of their beloved family members, friends or pets as well as store other valuables in a surreptitious manner.

The present invention provides a decorative timepiece and urn combination device that allows individual to display the ashes of their loved ones in a respectful manner, while also permitting the surreptitious storage of other valuables. The timepiece and urn combination device is preferably comprised of a base with a hidden compartment contained therein, a top, more than one pillar, a hourglass, and an hourglass support structure that permits the hourglass to rotate with respect thereto and without having to remove said hourglass from said hourglass support structure. The hourglass may be filled with sand, soil and/or the cremated remains of a loved one such as a family member, friend or pet. Alternatively, the cremated remains may be stored in the hidden compartment in the base with other valuables such as money, jewelry and the like.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof is an hourglass device that can also be used as a decorative urn to allow users to display the ashes of their loved one in a respectful manner, while also permitting the owner to store other valuables in a surreptitious manner. The timepiece and urn combination device is preferably comprised of a base with a hidden compartment contained therein, a top, more than one pillar, an hourglass support structure, and an hourglass. The hourglass may be filled with sand, soil and/or the cremated remains of a loved one such as a family member, friend or pet, or the cremated remains may be stored in the secret compartment in the base with other valuables such as money, jewelry and the like. Further, the hourglass support structure comprises a pivot clamp or axle that permits the hourglass to rotate with respect thereto, and permits the user to reset the hourglass without having to remove the hourglass from the hourglass support structure which could result in damage or breakage of the hourglass.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front elevational view of one embodiment of timepiece and urn combination device of the present invention.

FIG. 2 illustrates a side elevational view of the timepiece and urn combination device depicted in FIG. 1.

FIG. 3 illustrates a perspective view of the timepiece and urn combination device depicted in FIG. 1, but depicting an alternative embodiment of the base.

FIG. 4 illustrates a bottom perspective view of the timepiece and urn combination device depicted in FIG. 1 with the compartment cover installed thereon.

FIG. 4A illustrates a bottom perspective view of the base depicted in FIG. 4 with the door removed.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

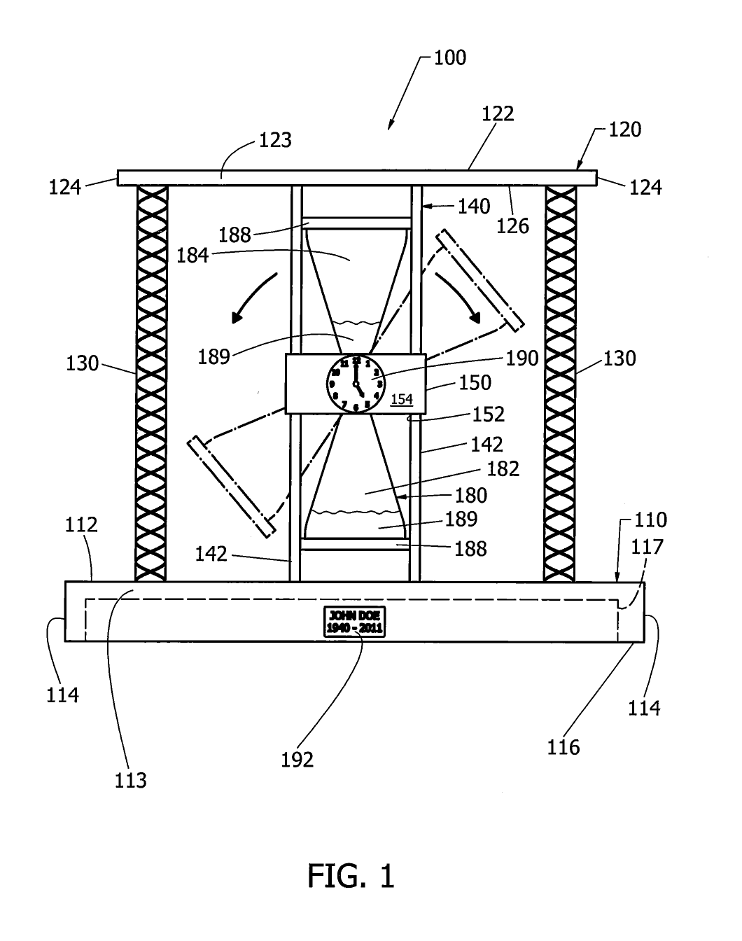

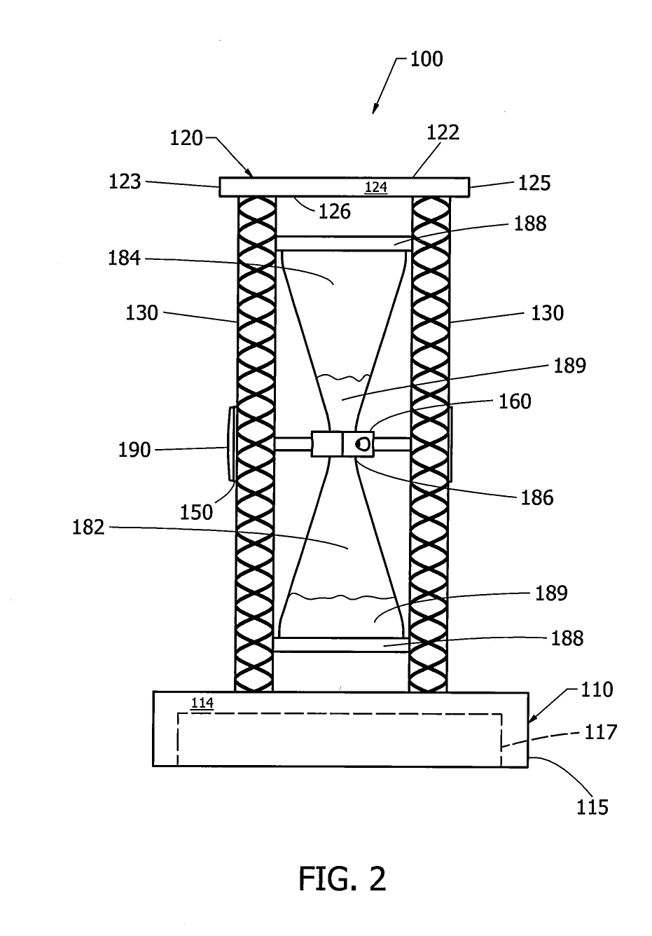

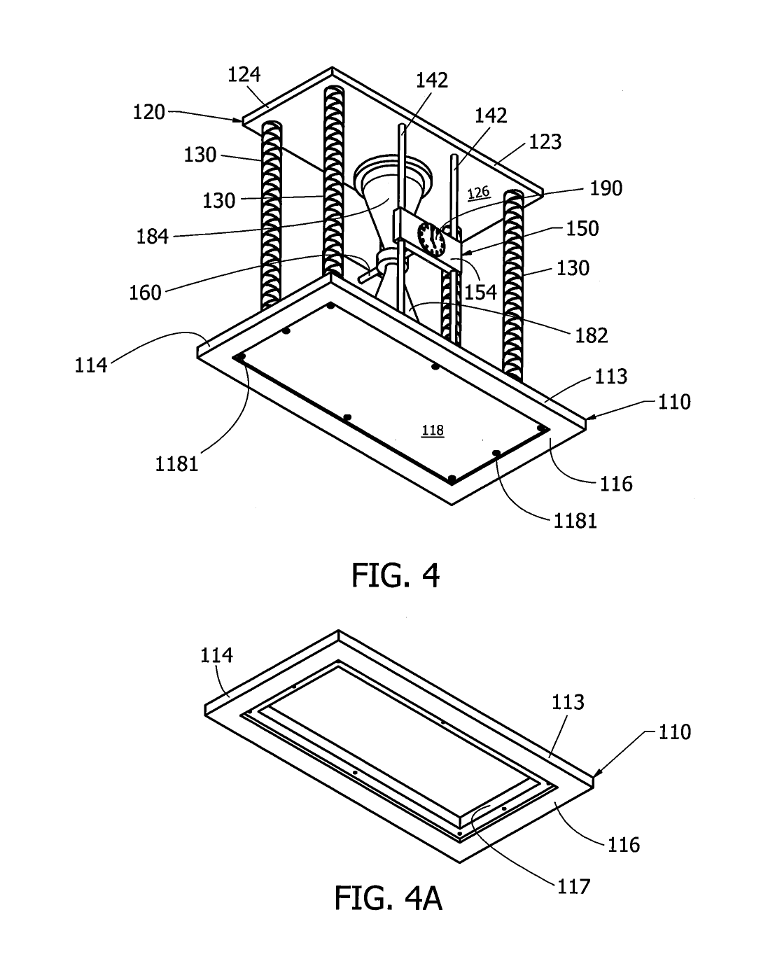

Referring initially to the drawings, FIG. 1 illustrates one embodiment of the timepiece and urn combination device 100 of the present invention. Device 100 preferably comprises a base 110, a top 120, more than one pillar 130, an hourglass support structure 140 and a hourglass 180. As best shown in the FIGS. 1 and 2, base 110 is preferably generally rectangular in shape and constructed out of a decorative material such as wood, metal, plastic, marble, stone or the like, though it is contemplated that other shapes and materials could be used without affecting the overall concept of the present invention. Base 110 is further comprised of a top surface 112, a front 113, sides 114, a back 115, a bottom surface 116, a hidden compartment 117 formed within said bottom 116 and a door 118 for accessing compartment 117, as best illustrated in FIGS. 4 and 4A and further described below.

In the preferred embodiment, base 110 is preferably between 8 to 16 inches in length measured between sides 114, between 6 to 14 inches in width measured from front 113 to back 115 and between 1 to 4 inches in height measured from top 112 to bottom 116, though it is contemplated that other sizes can also be used to suit user preference. Similarly, the dimensions of hidden compartment 117 are preferably between 7 to 15 inches in length measured from one side to the opposite side, between 5 to 13 inches in width measured from front to back and between ½ to 3½ inches in depth measured from bottom 116 and in the direction of top 112, though it is contemplated that other sizes can also be used to suit user preference provided that the dimensions of compartment 117 do not exceed those of base 110. Door 118 is preferably sized to correspond with the size of the opening of compartment 117 in bottom 116, as best illustrated in FIG. 4, and the exterior surface of door 118 is preferably substantially flush with bottom 116 when door 118 is properly installed on base 110. Door 118 can be removably installed on base 110 by any means as is commonly known in the art, such as with hinges (not shown) or with the use of fasteners 1181 such as screws and the like. It is also contemplated that door 118 could further comprise a handle and a lock (not shown) for preventing unauthorized access to compartment 117. As further described below, compartment 117 is useful for surreptitiously storing valuables such as money, jewelry, important paperwork, and the like. It is also contemplated that the remains of loved owns could also be stored within compartment 117.

Similar to base 110, top 120 is also preferably generally rectangular in shape and constructed out of a decorative material such as wood, metal, plastic, marble, stone or the like, though it is contemplated that other shapes and materials could also be used without affecting the overall concept of the present invention. Top 120 is further comprised of a top surface 122, a front 123, sides 124, a back 125, and a bottom surface 126, as best illustrated in the FIGS. In the preferred embodiment of the present invention, top 120 is in substantially parallel, spaced apart relationship with base 110, and is connected to base 110 by a plurality of decorative pillars 130. More specifically, each of said plurality of decorative pillars 130 is an elongated member that extends from, and is fixedly attached to, the top surface 112 of base 110 to the bottom surface 126 of top 120, where it is fixedly attached to top 120 by any means that is commonly known in the art such as with glue, epoxy, welding, fasteners, etc.

Each of pillars 130 is preferably cylindrical in shape and constructed out of a decorative material such as wood, metal, plastic, marble, stone or the like, though it is contemplated that other shapes and materials could be used without affecting the overall concept of the present invention. Further the decorative pillars 130 can be designed to represent any design, shape, pattern, etc., as is known in the art. The height of pillars 130, measured from the top surface 112 of base 110 to the bottom surface 126 of top 120 is preferably between 8 and 12 inches, though it is contemplated that pillars 130 could be taller or shorter without affecting the overall concept of the present invention, provided that the spacing between base 110 and top 120 is sufficient to accommodate the rotation of hourglass 180 as shown in dashed lines in FIG. 1. Pillars 130 are preferably positioned in substantially parallel, spaced apart relationship to one another along the top surface 112 of base 110 as depicted in the FIGS., though it is contemplated that other pillar arrangements could also be employed without affecting the overall concept of the present invention.

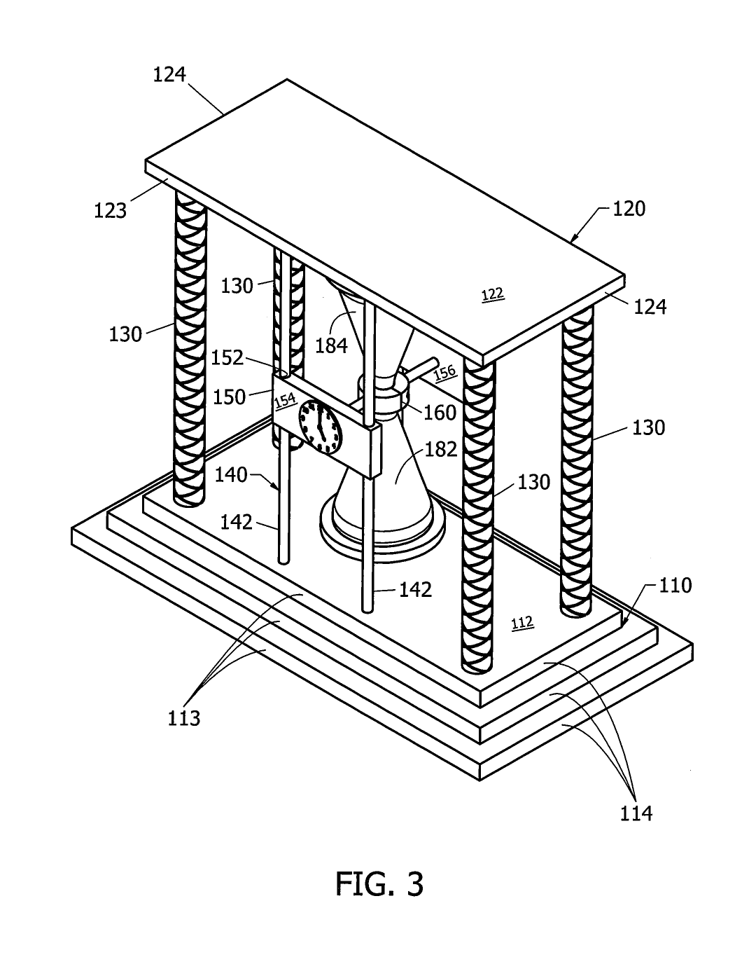

As best illustrated in FIG. 3, hourglass support structure 140 is preferably comprised of a plurality of posts 142, plates 150 and a pivot clamp or axle 160. Similar to pillars 130, each of said plurality of decorative posts 142 is an elongated member that extends from, and is fixedly attached to, the top surface 112 of base 110 to the bottom surface 126 of top 120, where it is fixedly attached to top 120 by any means that is commonly known in the art. Each of posts 142 is preferably cylindrical in shape and constructed out of a decorative material such as wood, metal, plastic, marble, stone or the like, though it is contemplated that other shapes and materials could be used without affecting the overall concept of the present invention. Further, decorative posts 142 can be designed to represent any design, shape, pattern, etc., as is known in the art. The height of posts 142 is substantially equal to the height of pillars 130. In the preferred embodiment of device 100, posts 142 are positioned in substantially parallel, spaced apart relationship to one another along the top surface 112 of base 110 as depicted in FIG. 3, with two of posts 142 positioned towards the front of base 110 (the front posts) and two posts 142 positioned towards the back of base 110 (the back posts), though it is contemplated that other post arrangements could also be employed.

The two front posts 142 are preferably connected to one another by a plate 150 as is depicted in FIG. 1, and the two back posts 142 are also preferably connected to one another by a plate 150 in similar fashion. Plates 150 can be of virtually any shape and size, and can be comprised of any decorative materials such as wood, metal, plastic, stone, and the like. Plates 150 are useful in adding strength to hourglass support structure 140, as well as supporting pivot clamp 160 and other ornamentation as is further described below. Plates 150 may be connected to posts 142 by any means commonly known in the art. For example, plates 150 may be glued or spot welded to posts 142, or each of plates 150 may further comprise continuous openings 152 therein for receipt of posts 142, as best illustrated in FIG. 3. Each of plates 150 further comprise an outboard surface 154 and an inboard surface 156, and a clock 190, or other decoration or ornamentation, can be attached to outboard surface 154 by any suitable means known in the art such as glue, epoxy, welds, screws, etc. Clock 190 can be any type of clock known in the art such as a digital clock or an analog clock, as is shown in FIG. 1.

In a preferred embodiment of the present invention, a pivot clamp 160 is attached to, and extends between, each of said inboard surfaces 156 to connect plates 150 to one another and to support hourglass 180, as shown in FIG. 3. Pivot clamps are well known in the art and can be secured around the neck 186 of hourglass 180, as described more fully below. For example, pivot clamp 160 may comprise a rod that encircles approximately half the circumference of the neck 186, and a second rod that encircles approximately the other half of the circumference of the neck 186, wherein such said rods are mated and secured via screws or any other suitable fastener as is known in the art and commonly used with pivot clamps. Once attached, pivot clamp 160 preferably substantially encircles the neck 186 for greater stability. As further described below, pivot clamp 160 permits hourglass 180 to rotate so that it can be reset without removing hourglass 180 from hourglass support structure 140.

Alternatively, and in lieu of pivot clamp 160, it is also contemplated that neck 186 could be attached to an axle or rod in any manner known in the art that would permit hourglass 180 to rotate about the axle as depicted in dashed lines in FIG. 1. It is also contemplated that pivot clamp 160 or axle could also extend from the inboard surface 156 of a single plate in a cantilever fashion, thereby eliminating the need for one of the plates 150, without affecting the overall concept of the present invention.

Hourglass 180 can be any hourglass typically known in the art and preferably comprises a first chamber 182 and a second chamber 184. The first chamber 182 and the second chamber 184 each comprise a first predetermined diameter and are separated by a neck 186 having a second, smaller diameter. Each of the first chamber 182 and the second chamber 184 are approximately between 3 and 4 inches in inside diameter, and approximately between 2 and 4 inches in height, though it is contemplated that different sized chambers 182, 184 could also be used without affecting the overall concept of the present invention provided that the overall size of hourglass 180 has sufficient clearance from the top surface 112 of base 110 and the bottom surface 126 of top 120 to rotate about pivot clamp 60 or an axle, as shown in FIG. 1.

In the preferred embodiment of the present invention, each of first chamber 182 and second chamber 184 may further comprise a stopper or cap 188 which is useful for filling and/or emptying the contents of first chamber 182 and second chamber 184 and which prevents the contents of the chambers 182, 184 from spilling. Stopper 188 may be removably attached to the end of the first chamber 182 opposite neck 186, and a second stopper 188 may be removably secured to the end of the second chamber 184 opposite neck 186. Stoppers 188 are removably secured via any typical fastening means such as friction fit, threading, etc. It is also contemplated that only one chamber may contain a stopper 188 and that the other chamber may be permanently sealed, or that both chambers can be partially filled with sand, soil and/or ash and be permanently sealed as is known in the art.

Neck 186 provides a continuous opening between first chamber 182 and second chamber 184 for permitting the contents 189 to flow between chambers via gravitational force as is known in the art. At its narrowest point, neck 186 is preferably between 1/64 and ½ of an inch in interior diameter, but should be sized in accordance with user preference. For example, the duration of an hourglass cycle (i.e., the time it takes for the contents of one chamber to flow entirely into a second chamber) is a function of, among other things, the size of the opening in neck 186 and the amount of the contents (i.e., sand, ash, etc.) that must pass therethrough.

First chamber 182 and second chamber 184 are typically hollow, funnel-shaped chambers, however any other suitable shape can be used such as rounded, oval, etc. without affecting the overall concept of the invention. First chamber 182, second chamber 184, and neck 186 are also preferably constructed of glass, though any other suitable material may be used. The contents 189 of the chambers 182, 184 can comprise the cremated remains of an individual or animal, sand, symbolic soil, and/or a combination of these, etc.

It is also contemplated that a commemorative name plate 192 could be affixed to device 100. For example, FIG. 1 depicts name plate 192 attached to the front 113 of base 110. Name plate 192 may contain virtually any combination of messages, letters, numbers, or symbols and can be designed to user preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A combination timepiece and urn device comprising:
a base, wherein said base further comprises a hidden compartment contained therein;
a top;
more than one pillar;
a hourglass support structure; and
a hourglass.

2. The combination timepiece and urn device of claim 1, wherein said hourglass support structure further comprises a means for permitting the hourglass to rotate without removing said hourglass from the hourglass support structure.

3. The combination timepiece and urn device of claim 2, wherein said means for permitting the hourglass to rotate without removing said hourglass from the hourglass support structure is a pivot clamp.

4. The combination timepiece and urn device of claim 2, wherein said means for permitting the hourglass to rotate without removing said hourglass from the hourglass support structure is an axle.

5. The combination timepiece and urn device of claim 1, wherein said hourglass support structure further comprises a plurality of posts, at least one plate and a pivot clamp.

6. The combination timepiece and urn device of claim 1, wherein said hidden compartment further comprises a door with a lock.

7. The combination timepiece and urn device of claim 1, wherein said more than one pillar connects the base to the top.

8. The combination timepiece and urn device of claim 1, wherein said device further comprises a clock.

9. A combination timepiece and urn device comprising:
a base, wherein said base further comprises a hidden compartment contained therein;
a top;
more than one pillar;
a hourglass; and
a hourglass support structure, wherein said hourglass support structure further comprises a plurality of posts, at least one plate and a pivot clamp.

10. The combination timepiece and urn device of claim 9, wherein said hidden compartment further comprises a door with a lock.

11. The combination timepiece and urn device of claim 9, wherein said more than one pillar connects the base to the top.

12. The combination timepiece and urn device of claim 9, wherein said hourglass support structure further comprises at least one of a clock or a nameplate.

13. The combination timepiece and urn device of claim 9, wherein said pivot clamp permits said hourglass to rotate without removing said hourglass from the hourglass support structure.

14. The combination timepiece and urn device of claim 9, wherein said at least one plate is attached to at least one of said plurality of posts.

15. A combination timepiece and urn device comprising:
a base, wherein said base further comprises a hidden compartment contained therein;
a top;
more than one pillar;
a hourglass; and
a hourglass support structure, wherein said hourglass support structure further comprises a plurality of posts, at least one plate and an axle for permitting said hourglass to rotate without removing said hourglass from said hourglass support structure.

16. The combination timepiece and urn device of claim 15, wherein said hidden compartment further comprises a door with a lock.

17. The combination timepiece and urn device of claim 15, wherein said more than one pillar connects the base to the top.

18. The combination timepiece and urn device of claim 15, wherein said device further comprises a clock.

19. The combination timepiece and urn device of claim 15, wherein said at least one plate is attached to at least one of said plurality of posts.

20. The combination timepiece and urn device of claim 15, wherein least one of said plurality of posts connects the base to the top.
